(19) United States
(12) Patent Application Publication
(10) Pub. No.: US 2021/0407002 A1
(43) Pub. Date: Dec. 30, 2021

(54) SYSTEMS AND METHODS FOR INTRADAY FOREIGN EXCHANGE USING DISTRIBUTED LEDGER TECHNOLOGY

(71) Applicant: JPMORGAN CHASE BANK, N.A., New York, NY (US)

(72) Inventors: Christine MOY, New York, NY (US); George KASSIS, London (GB); Alex PRAGER-MILLER, New York, NY (US); Stuart HUNTER, New York, NY (US); Scott Andrew LUCAS, St. Albans (GB)

(21) Appl. No.: 17/362,579

(22) Filed: Jun. 29, 2021

Related U.S. Application Data
(60) Provisional application No. 63/045,659, filed on Jun. 29, 2020.

(51) Int. Cl. G06Q 40/04; G06Q 20/38; G06Q 30/00; G06Q 20/08; G06Q 40/02; G06F 16/23

(52) U.S. Cl. CPC G06Q 40/04; G06Q 20/389; G06Q 30/018; G06F 16/2365; G06Q 20/381; G06Q 40/025; G06Q 20/085

(57) ABSTRACT

A method may include: receiving, at a marketplace, a buyer submission from a buyer comprising an identification of a first currency, an identification of a target currency, an amount of the target currency, a target annual percentage yield, a maturity, and a buyer attestation; receiving, at the marketplace, a lender submission identifying an amount of tokens in the target currency for exchange, a fee, and a lender attestation; matching, by a matching engine for the marketplace, the buyer to the lender based on the buyer submission and the lender submission; verifying, by a smart contract at the marketplace, the buyer attestation and the lender attestation; transferring, by the marketplace, the tokens in the target currency to the buyer, wherein the buyer submits the tokens in the target currency to a staking smart contract; and transferring, by the marketplace, the tokens in the target currency to the lender at maturity.

### RELATED APPLICATIONS

This application claims the benefit of, and priority to, U.S. Provisional Patent Application Ser. No. 63/045,659, filed Jun. 29, 2020, the disclosure of which is hereby incorporated, by reference, in its entirety.

### BACKGROUND OF THE INVENTION

### 1. Field of the Invention

Embodiments relate generally to systems and methods for intraday foreign exchange using distributed ledger technology.

### 2. Description of the Related Art

Under existing infrastructure, there is no way for large financial institutions to engage in an intraday foreign exchange (FX) agreement or transaction. For example, Financial Institution A may hold large amounts of EUR, but at the beginning of the day, foresees payment obligations in USD throughout the day. Financial Institution A does not have USD to meet the obligations, and therefore needs USD just for a few hours as it expects to receive USD later in the day.

### SUMMARY OF THE INVENTION

Systems and methods for intraday foreign exchange using distributed ledger technology are disclosed. In one embodiment, a method for intraday foreign exchange using distributed ledger technology may include: (1) receiving, at a marketplace, a plurality of submissions from a plurality of parties for an intraday foreign exchange, each submission comprising an identification of a first currency, an identification of a target currency, an amount of the target currency, a maturity, and an attestation for the party; (2) matching, by a matching engine for the marketplace, two of the parties based on their submissions; (3) verifying, by a smart contract at the marketplace, the attestations for the matched parties; (4) receiving, at the marketplace, first tokens from a first matched party in the first currency; (5) receiving, at the marketplace, second tokens from a second matched party in the second currency; (6) transferring, by the marketplace, the first tokens to the second matched party, and the second tokens to the first matched party; (7) crediting, by the marketplace, a currency account for the first matched party with the amount of the target currency; (8) debiting, by the marketplace, the amount of target currency from the currency account for the first matched party at maturity; and (9) transferring, by the marketplace, the second tokens to the second matched party, and the first tokens to the first matched party.

In one embodiment, at least one of the submissions further may include an attestation requirement, and the matching may be further based on the attestation requirement and the attestations. The matching may also be based on a regional requirement, a regulatory requirement, a legal requirement, etc.

In one embodiment, the attestation may be blockchain-based and attests to the party's authority.

In one embodiment, the submissions further comprise a digital identifier, and the smart contract further validates the digital identifiers for the matched parties.

In one embodiment, the method may further include debiting, by the marketplace, a fee from the first tokens.

According to another embodiment, a method for intraday foreign exchange using distributed ledger technology may include: (1) receiving, at a marketplace, a buyer submission from a buyer comprising an identification of a first currency, an identification of a target currency, an amount of the target currency, a target annual percentage yield (APY), a maturity, and a buyer attestation; (2) receiving, at the marketplace, a lender submission from a lender identifying an amount of tokens in the target currency available for exchange, a fee, and a lender attestation; (3) matching, by a matching engine for the marketplace, the buyer to the lender based on the buyer submission and the lender submission; (4) verifying, by a smart contract at the marketplace, the buyer attestation and the lender attestation; (5) transferring, by the marketplace, the tokens in the target currency to the buyer, wherein the buyer submits the tokens in the target currency to a staking smart contract; and (6) transferring, by the marketplace, the tokens in the target currency to the lender at maturity.

In one embodiment, at least one of the submissions further may include an attestation requirement, and the matching may be further based on the attestation requirement and the attestations. The matching may also be based on a regional requirement, a regulatory requirement, a legal requirement, etc.

In one embodiment, the buyer attestation may be blockchain-based and attests to the buyer's authority, and the lender attestation may be blockchain-based and attests to the lender's authority

In one embodiment, the submissions may also include a digital identifier, and the smart contract further validates the digital identifier for the matched parties.

In one embodiment, the method may further include receiving, from a pricing oracle, pricing information for the target currency comprising a current APY for the target currency; and triggering the transfer of the tokens in the target currency to the buyer in response to the current APY matching the target APY.

According to another embodiment, a system for intraday foreign exchange using distributed ledger technology may include: a marketplace comprising a matching engine; and a distributed ledger network comprising a plurality of smart contracts, wherein a plurality of buyers and a plurality of lenders access the distributed ledger network. The matching engine may receive a buyer submission comprising an identification of a first currency, an identification of a target currency, an amount of the target currency, a target annual percentage yield (APY), a maturity, and a buyer attestation and may receive a lender submission identifying an amount of tokens in the target currency available for exchange, a fee, and a lender attestation. The matching engine may match the buyer to the lender based on the buyer submission and the lender submission. One of the smart contracts may verify the buyer attestation and the lender attestation. The marketplace may transfer the tokens in the target currency to the buyer, wherein the buyer submits the tokens in the target currency to a staking smart contract, and may transfer the tokens in the target currency to the lender at maturity.

In one embodiment, at least one of the submissions further may include an attestation requirement, and the matching may be further based on the attestation requirement and the attestations.

In one embodiment, the matching may be further based on a regional requirement, a regulatory requirement, and/or legal requirement.

In one embodiment, the buyer attestation may be blockchain-based and attests to the buyer's authority, and the lender attestation may be blockchain-based and attests to the lender's authority.

In one embodiment, the submissions may also include a digital identifier, and the smart contract further validates the digital identifiers for the matched parties.

In one embodiment, the system may further include a pricing oracle, and the marketplace may receive pricing information for the target currency comprising a current APY for the target currency and triggers the transfer of the tokens in the target currency to the buyer in response to the current APY matching the target APY.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for intraday foreign exchange using distributed ledger technology according to an embodiment;

FIG. 2 depicts a method for intraday foreign exchange using distributed ledger technology according to one embodiment;

FIG. 3 depicts a method for intraday foreign exchange using distributed ledger technology according to one embodiment;

FIG. 4 depicts a system for intraday foreign exchange using distributed ledger technology according to another;

FIG. 5 depicts a method for intraday foreign exchange using distributed ledger technology according to another embodiment;

### DETAILED DESCRIPTION OF PREFERRED EMBODIMENTS

The disclosures of U.S. Provisional Patent Application Ser. No. 62/757,614, filed Nov. 8, 2018, and U.S. patent application Ser. No. 16/677,609, filed Nov. 7, 2019 are hereby incorporated, by reference, in their entireties.

Embodiments relate generally to systems and methods for intraday foreign exchange using distributed ledger technology. In embodiments, a financial institution may use an amount of a first currency as collateral for an amount of a second currency. Using the example above, Financial Institution A may use its EUR as collateral for USD for a short, intraday period of time, and unwind the agreement to receive the EUR back before the end of the day.

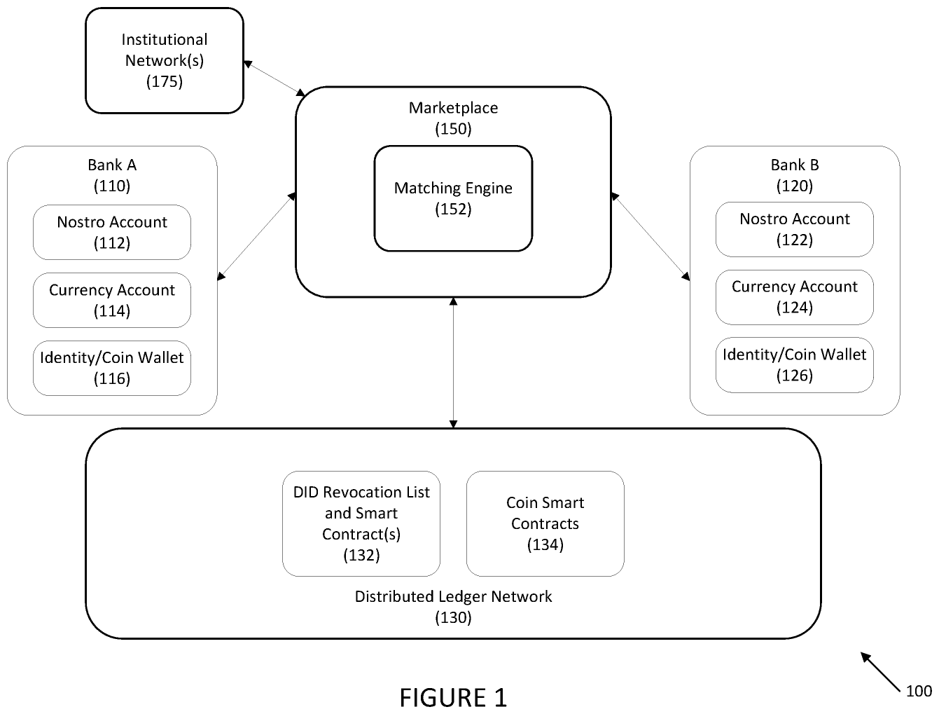

Referring to FIG. 1, a system for intraday foreign exchange using distributed ledger technology according to an embodiment. System 100 may include Bank A 110, which may be a bank that holds funds in a first currency, and Bank B 120, which may hold currency in a second currency. Bank A 110 and Bank B 120 may seek to participate in an intraday foreign exchange of the first currency for the second currency.

Bank A 110 and Bank B 120 may each participate as nodes in distributed ledger network 130. Distributed ledger network 130 may maintain accounts for Bank A 110 and Bank B 120, such as Bank A nostro account 112, Bank A currency account 114, Bank B nostro account 122, and Bank B currency account 124. The accounts may be maintained by their respective banks but may be maintained by the respective banks and may interact with one or more smart contract (e.g., coin smart contract 134). For example, entities with identity/coin wallets (e.g., identity/coin wallet 116 or 126) may have their own node, or may interact with another entity that has a node (e.g., a guardian), etc.

Bank A token account 112 and Bank B token account 122 may be nostro accounts.

Bank A 110 and Bank B 120 may further include identity/coin wallets 116 and 126, respectively. In one embodiment, wallets 116 and 126 may store coins (e.g., stablecoins, ERC20 tokens, etc.), digital identities, and attestations (e.g., blockchain-based credentials).

In one embodiment, identity/coin wallets 116 and/or 126 may interact with one or more smart contracts provided on distributed ledger network 130, such as DID revocation list and smart contract(s) 132 and coin smart contracts and 134.

Distributed ledger network 130 may include a plurality of distributed ledger-based networks, and may use different technologies for different smart contracts. For example, coin smart contracts 134 may be provided on a Quorum-based distributed ledger, while coin smart contracts 134 may be provided on a public Ethereum smart contract. Other technologies may be used as is necessary and/or desired.

Note that although only two banks (i.e., Bank A 110 and Bank B 120) are depicted in FIG. 1, it should be recognized that a greater number of banks and/or entities may participate as is necessary and/or desired. In embodiment, the banks and/or entities may participate using a variety of currencies as is necessary and/or desired.

In addition, Bank A 110 and Bank B 120 may be other types of entities, users, etc. as is necessary and/or desired.

System 100 may further include marketplace 150. Marketplace 150 may provide participants (e.g., Bank A 110, Bank B 120, other participants, etc.) to submit transactions, such as intraday foreign exchange (FX) transactions. The transactions may be submitted using, for example, an application, a web portal, etc. and may include parameters, such as the timing of the transaction, the submitter's currency, the desired currency, the desired fee, the desired maturity time, etc. Matching engine 152, which may be a computer program executed by marketplace 150 may match different submissions and identify counterparties to each other.

Marketplace 150 may have thousands of parties on each side, and matching engine 152 may match the users based on timing, maturity, currency, etc. as well as the attestations they have shared and/or requested. For example, a party may require a counterparty to have one or more certain attestations (e.g., a certain know your customer attestation), and matching engine 152 may match the users accordingly.

In one embodiment, the submitting parties may provide digital identities (DIDs) issued by an identity provider that may confirm the identity of each party. The parties may also submit attestations that may attest to certain characteristics of the party, such as the authority of the party to conduct the transaction. Matching engine 152 or a similar program may validate the DIDs and/or the attestations for each party as part of the matching process. Because of this, the identity of the matched parties may not be disclosed to each other.

In one embodiment, matching engine 152 may match the parties based on, for example, one or more regional requirements. For example, banks from certain regions interacting with other banks may need certain attestations, may need to comply with certain legal and/or regulatory requirements, etc. Matching engine 152 may consider these factors in matching the parties as is necessary and/or desired.

Further, to the extent that a party needs to retain certain attestation information, a portion of the counterparty's attestation may be shared. The entire attestation may not be provided; only the relevant information required by the party may be provided and maintained by the requesting/receiving party. An example is instead of providing the requesting party with the counterparty's legal entity identifier number, the requesting party may be informed that the counterparty has a legal entity identifier.

In one embodiment, the attestations and/or DIDs may be verified on-chain by one or more smart contracts, such as DID revocation list and smart contract(s) 132. DID revocation list and smart contract(s) 132 may check each user's attestation to make sure they are valid and have not been revoked.

In one embodiment, DID revocation list and smart contract(s) 132 may maintain a list of all revoked DIDs.

DID revocation list and smart contract(s) 132 may sit between the parties and may verify the party's attestations and/or DIDs without the parties needing to see any of the details about the other party. This provides privacy and may also ensure that certain requirements, such as know your customer requirements, anti-money laundering requirements, local requirements, etc. are met.

Institutional network 175 may be one or more networks, such as the Liink network, public and or private distributed ledger networks, etc.

In another embodiment, matching engine 152 may retrieve results from the smart contract.

Examples of digital identities and attestations are described in U.S. patent application Ser. No. 16/878,457, filed May 19, 2020, and U.S. Provisional Patent Application Ser. No. 62/850,181, filed May 20, 2019, U.S. Provisional Patent Application Ser. No. 62/976,262 filed Feb. 13, 2020, U.S. Provisional Patent Application Ser. No. 63/126,335 filed Dec. 16, 2020, and U.S. patent application Ser. No. 17/174,650 filed Feb. 12, 2021, the disclosures of which are hereby incorporated, by reference, in their entireties.

Distributed ledger network 130 e may further include one or more coin smart contracts 134. In one embodiment, coin smart contracts 134 may mint tokens (e.g., stablecoins, ERC20 coins, etc.).

System 100 may further include an identity network (not shown), which may provide DID verification services. Example of such a network are provided in U.S. patent application Ser. No. 16/878,457, filed May 19, 2020, U.S. Provisional Patent Application Ser. No. 62/850,181, filed May 20, 2019, U.S. Provisional Patent Application Ser. No. 62/976,262 filed Feb. 13, 2020, U.S. Provisional Patent Application Ser. No. 63/126,335 filed Dec. 16, 2020, and U.S. patent application Ser. No. 17/174,650 filed Feb. 12, 2021, the disclosures of which are hereby incorporated, by reference, in their entireties.

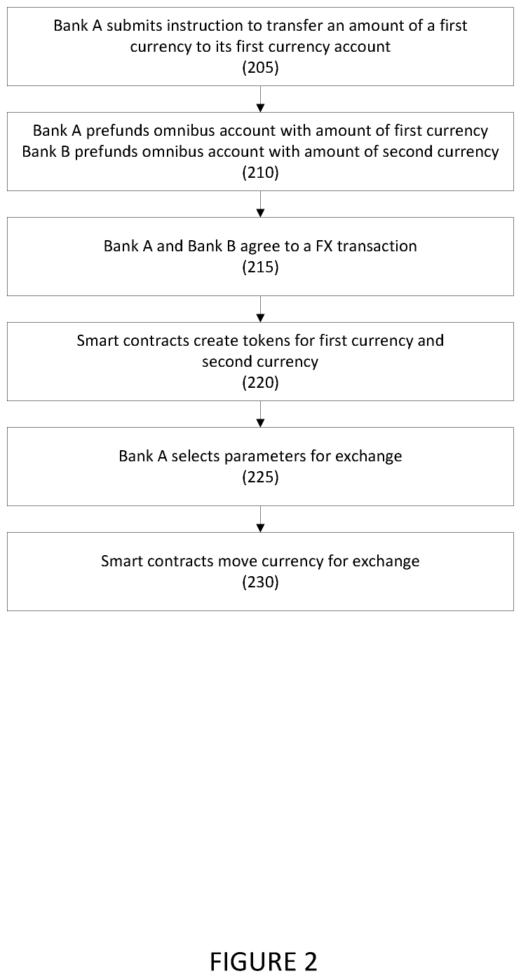

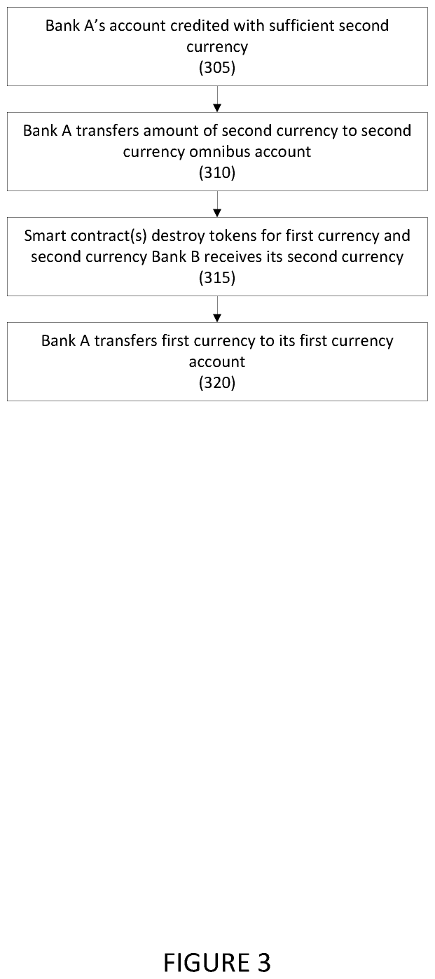

Referring to FIGS. 2 and 3, methods for intraday foreign exchange using distributed ledger technology are disclosed according to embodiments.

In step 205, a first bank (Bank A) may submit an instruction to transfer an amount of a first currency to its first currency account. In one embodiment, the instruction may be sent using the Swift network or any other suitable network. This may effectively credit Bank A's first currency account.

In step 210, Bank A may prefund an omnibus account by moving the amount of the first currency into its first currency omnibus/nostro account on the distributed ledger. A counterparty second bank (Bank B), may prefund a secondary currency omnibus/nostro account by moving a corresponding amount of a second currency to its omnibus account within the bank.

In step 215, Bank A and Bank B may agree to a FX transaction. Alternatively, Bank A may submit an order, and a matching engine may identify one or more counterparties that match the order. In one embodiment, this may occur on a separate platform (e.g., not on distributed ledger network 130), and it may occur before each party's accounts are prefunded, after the accounts are prefunded, etc. If the accounts are prefunded, step 220 may occur before step 215. In one embodiment, Bank A and Bank B may be participants in a marketplace, and may submit a request for an intraday FX transaction to the marketplace. In one embodiment, a plurality of parties may participate in a plurality of currencies, and the marketplace may match parties based on their submissions. In one embodiment, a matching engine provided by the marketplace may match the parties based on their submissions. In embodiments, the matching engine may further use each party's DID or attestations to match the parties.

In one embodiment, the identities of the parties may remain secret from each other as is necessary and/or desired.

In step 220, once agreed to, Bank A and Bank B may move their funds (e.g., in the first currency and the second currency) to their respective wallets. For example, once the funds are moved, they may be locked and tokenized into tokens, such as stablecoins, ERC20 coins, etc. by one or more smart contracts. Once this is complete, the wallets for the banks may be funded with their newly minted coins.

In one embodiment, each bank may have visibility into its own token balance, but not the other party's.

In another embodiment, the distributed ledger network may be permissioned and/or private, and the balances and other information may be not be available to other entities.

Examples of tokenization are disclosed in U.S. Provisional Patent Application Ser. No. 62/757,614 and U.S. patent application Ser. No. 16/677,609, filed Nov. 7, 2019.

In step 225, Bank A may select parameters for the FX transaction (e.g., amount, maturity time, target currency, and any fee that was agreed to) and may submit the transaction to the distributed ledger network for execution.

In one embodiment, Bank A may also select a start time (e.g., immediate, in 2 hours, etc.), and, at that time, the platform may automatically trigger the FX transaction at that time. For this period of time, Bank A owns the tokens for the second currency, and Bank B owns the tokens for the first currency.

In one embodiment, a smart contract may move the tokens by writing a change in ownership to the distributed ledger.

In step 230, one or more smart contract may move the second currency from the secondary currency omnibus/nostro account to Bank A's second currency account. Using its second currency account, Bank A may make second currency payments, such as payments via Swift or by any other suitable mechanism. Bank B would have ownership of the first currency.

Referring to FIG. 3, before maturity (e.g., the time specified in the FX transaction parameters), in step 305, Bank A's second currency account may be credited with second currency that meets or exceeds the amount of second currency used for payment obligation(s).

In step 310, also before maturity, Bank A may transfer the pre-agreed amount of the second currency back into the second currency omnibus/nostro account.

In step 315, at maturation, smart contract(s) may destroy the first currency tokens and the second currency tokens, and the first currency moves from the first currency omnibus/nostro account to Bank A's first currency account. Bank B no longer has ownership of the first currency, and receives the second currency back from Bank A.

In addition, the agreed-upon fee may be deducted from Bank A's token balance.

In step 320, Bank A may transfer the first currency from Bank A's first currency account via, for example, Swift or any other suitable payment network, to its Bank A account prior to the cutoff time.

In embodiments, the use of a distributed ledger may provide at least some of the following advantages: it enables parties to engage in an intraday FX transaction which offer an “atomic swap” where both tokens get automatically exchanged; parties value this service as it allows them to have quick access to currencies to be able to meet their payment obligations; and unlike current uncommitted intraday credit facilities offered by banks, embodiments create an intraday FX marketplace where the process is monitored, controlled, and the service is potentially charged for.

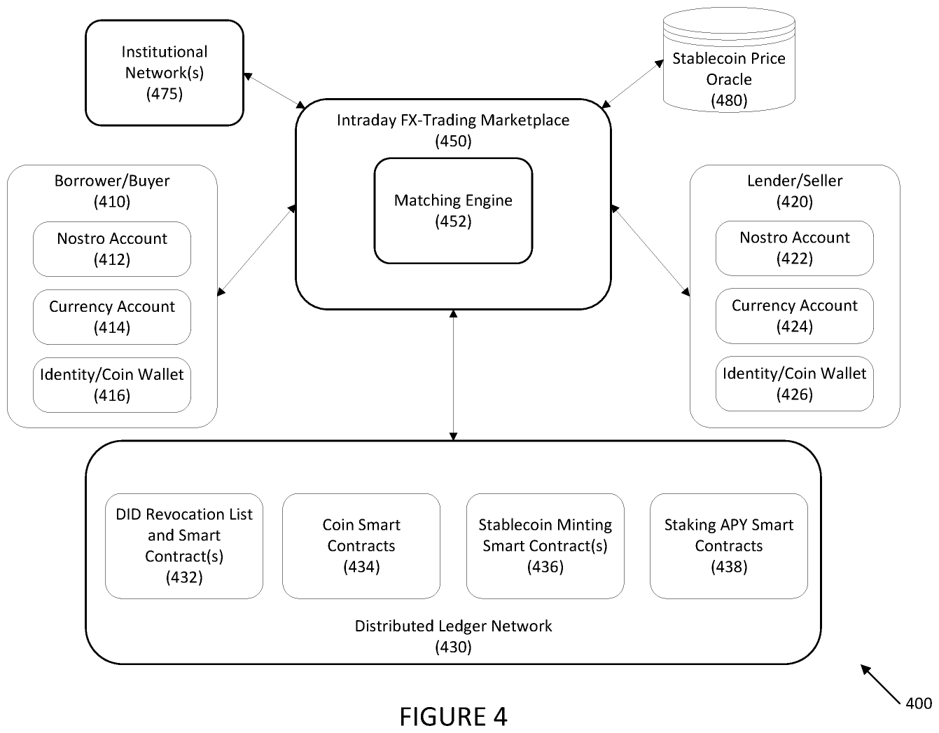

Referring to FIG. 4, a system for intraday FX transaction is disclosed according to another embodiment. System 400 may include a plurality of borrowers/buyers 410, a plurality of lenders/sellers 420, and intraday FX-Trading Marketplace 450. Intraday FX-Trading Marketplace 450 may include matching engine 452. In one embodiment, matching engine 452 may be a computer program that may receive submissions from one or more borrower/buyer(s) 410 and one or more lender/seller(s) 420 and may match the parties having the same, or substantially the same submission parameters.

In one embodiment, borrow/buyer(s) 410 and/or lender/seller(s) 420 may each participate as nodes in distributed ledger network 430. Distributed ledger network 430 may maintain accounts for borrow/buyer(s) 410 and lender/seller(s) 420, such nostro account 412, currency account 414, nostro account 422, and currency account 424. The accounts may be maintained by their respective banks but may be maintained by the respective banks and may interact with one or more smart contract (e.g., coin smart contract 434). For example, entities with identity/coin wallets (e.g., identity/coin wallet 416 or 426) may have their own node, or may interact with another entity that has a node (e.g., a guardian), etc.

Borrow/buyer(s) 410 and lender/seller(s) 420 may further include identity/coin wallets 416 and 426, respectively. In one embodiment, wallets 416 and 426 may store coins (e.g., stablecoins, ERC20 tokens, etc.), digital identities, and attestations.

Distributed ledger network 430 may include a plurality of smart contracts. For example, DID revocation list and smart contract(s) 432 may check each user's attestation to make sure they are valid and have not been revoked. In one embodiment, DID revocation list and smart contract(s) 432 may maintain a list of all revoked DIDs.

DID revocation list and smart contract(s) 432 may sit between the parties and may verify the party's attestations and/or DIDs without the parties needing to see any of the details about the other party. This provides privacy and may also ensure that certain requirements, such as know your customer requirements, anti-money laundering requirements, local requirements, etc. are met.

Coin smart contracts 434 may mint tokens (e.g., stablecoins, ERC20 coins, etc.). Stablecoin smart contract(s) 436 may mint and/or stake stablecoins in liquidity pools as collateral if needed, or may lock collateral in liquidity pools if needed. Staking annual percentage yield (APY) smart contracts 438 may offer different APY's when stablecoins are deposited in that smart contract. Staking APY smart contracts 438 may be provided for stablecoins of different currencies.

In one embodiment, identity/coin wallets 416 and/or 426 may interact with one or more smart contracts provided on distributed ledger network 430, such as DID revocation list and smart contract 432, coin smart contracts 434, stablecoin minting smart contracts 436, etc.

Distributed ledger network 430 may include a plurality of distributed ledger-based networks, and may use different technologies for different smart contracts. For example, coin smart contracts 434 may be provided on a Quorum-based distributed ledger, while coin smart contracts 434 may be provided on a public Ethereum smart contract. Other technologies may be used as is necessary and/or desired.

In embodiments, borrowers/buyers 110 may want access to a stablecoin (e.g., digital U.S. dollars) for just 1 hour to benefit from a high APY or engage in short term decentralized finance (DEFI) products. Lenders/sellers 120 may lend the coins to borrower/buyer 110 and may charge a fee, a percent of the interest, etc.

In one embodiment, marketplace 450 may further charge a fee, a percent of the interest, etc.

In one embodiment, each of party may submit a source currency, a desired currency, an amount, a time, and any other parameters. In one embodiment, the parameters may specify an APY that may trigger the transaction. In one embodiment, the parameters may be received from smart contracts (not shown) for the DEFI products.

Each borrower/buyer 110 and each lender/seller 120 may maintain or be associated with one or more wallets that may store tokens (e.g., ERC20 tokens, stablecoins, etc.), digital identities, attestations, etc.

System 400 may further include stablecoin price oracle 480 that may provide information, such as APY information, for one or more stablecoin currency. The APY may vary on an intraday basis and the APY may be provided in real time, or substantially in real time.

In one embodiment, stablecoin price oracle 480 may further provide pricing information for stablecoins, etc.

In one embodiment, the APYs may be provided by one or more smart contract.

System 400 may further include an identity network (not shown), which may provide DID verification services. Example of such a network are provided in An example of a digital identity is described in U.S. patent application Ser. No. 16/878,457, filed May 19, 2020, and U.S. Provisional Patent Application Ser. No. 62/850,181, filed May 20, 2019, the disclosures of which are hereby incorporated, by reference, in their entireties.

Institutional network 475 may be one or more networks, such as the Liink network, public and or private distributed ledger networks, etc.

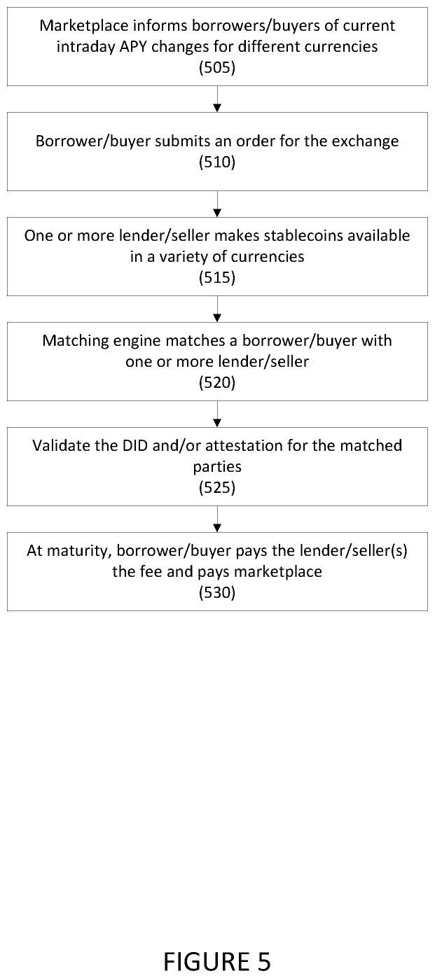

Referring to FIG. 5, a method for intraday FX transactions is provided according to another embodiment. A borrower/buyer may have first currency stablecoin but now wants to obtain second currency stablecoin as the APY for the second currency has spiked.

The borrower/buyer may monitors APY changes of trusted smart contracts via the marketplace, and may swap the first currency stablecoin for the second currency stablecoin for a period of time, earn interest, and pay a portion back to the lender/seller and a portion back the marketplace.

In step 505, the marketplace may inform borrowers/buyers of current intraday APY changes for different currencies. In one embodiment, the marketplace may obtain the information from one or more smart contract. For example, the marketplace may ingest information from smart contract, such as APY information, and may inform the borrowers/buyers of APY changes. In one embodiment, the borrowers/buyers may establish triggers based on APY change thresholds.

In step 510, the borrower/buyer may submit an order for the exchange. In one embodiment, the borrower/buyer may submit an amount, a timeframe, and its DID and/or attestation(s) to the marketplace. It may further submit a maximum fee for the service.

In one embodiment, the borrower/buyer may identify a target APY for triggering the transaction.

In step 515, one or more lender/seller may make stablecoins available in a variety of currencies. In one embodiment, the lenders/sellers may specify the fee it will charge. The lender/seller may also provide its DID and/or attestation(s).

In step 520, the matching engine may match a borrower/buyer with one or more lender/seller. In one embodiment, the matching engine may use the submissions to match the two or more parties.

In one embodiment, the matching engine may match the borrower/buyer with one or more lender/seller based on the submission (e.g., price, currency, timing, etc.). The matching engine may further match the borrower/buyer with one or more lender/seller based on DIDs and/or credentials submitted or requested by the parties. For example, the matching engine may receive the submissions from the parties (e.g., current APY, target APY, maturity times, duration of trades, and any DID/attestation requirements to match the parties. In addition, the matching engine may further match the parties based on regional requirements, legal/regulatory requirements, etc.

The matching may be continuous (e.g., 24 hours a day, seven days a week) as the stablecoin markets do not close.

In step 525, the matching engine and/or a smart contract may validate the DID and/or attestation for the parties. In one embodiment, the matching engine may maintain anonymity of the parties as necessary and/or desired. Because the DIDs and/or attestations have been validated, the parties can have confidence in the transaction.

In step 530, the borrower/buyer may receive the coins in the second currency and may stake them in a smart contract. This may be part of the marketplace or a separate platform (e.g., out of band).

The borrower/buyer may then earn interest.

In step 530, at maturity, the borrower/buyer may pay the lender/seller(s) the fee, and may further pay the marketplace. If there are multiple lenders, the fee may be split between the lenders.

Although multiple embodiments have been described, it should be recognized that these embodiments are not exclusive to each other, and that features from one embodiment may be used with others.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object oriented programming The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. It is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for intraday foreign exchange using distributed ledger technology, comprising:
receiving, at a marketplace, a plurality of submissions from a plurality of parties for an intraday foreign exchange, each submission comprising an identification of a first currency, an identification of a target currency, an amount of the target currency, a maturity, and an attestation for the party;
matching, by a matching engine for the marketplace, two of the parties based on their submissions;
verifying, by a smart contract at the marketplace, the attestations for the matched parties;
receiving, at the marketplace, first tokens from a first matched party in the first currency;
receiving, at the marketplace, second tokens from a second matched party in the second currency;
transferring, by the marketplace, the first tokens to the second matched party, and the second tokens to the first matched party;
crediting, by the marketplace, a currency account for the first matched party with the amount of the target currency;
debiting, by the marketplace, the amount of target currency from the currency account for the first matched party at maturity; and
transferring, by the marketplace, the second tokens to the second matched party, and the first tokens to the first matched party.

2. The method of claim 1, wherein at least one of the submissions further comprises an attestation requirement, and the matching is further based on the attestation requirement and the attestations.

3. The method of claim 1, wherein the matching is further based on a regional requirement.

4. The method of claim 1, wherein the matching is further based on a regulatory requirement or a legal requirement.

5. The method of claim 1, wherein the attestation is blockchain-based and attests to the party's authority.

6. The method of claim 1, wherein the submissions further comprise a digital identifier, and the smart contract further validates the digital identifiers for the matched parties.

7. The method of claim 1, further comprising:
debiting, by the marketplace, a fee from the first tokens.

8. A method for intraday foreign exchange using distributed ledger technology, comprising:
receiving, at a marketplace, a buyer submission from a buyer comprising an identification of a first currency, an identification of a target currency, an amount of the target currency, a target annual percentage yield (APY), a maturity, and a buyer attestation;
receiving, at the marketplace, a lender submission from a lender identifying an amount of tokens in the target currency available for exchange, a fee, and a lender attestation;
matching, by a matching engine for the marketplace, the buyer to the lender based on the buyer submission and the lender submission;
verifying, by a smart contract at the marketplace, the buyer attestation and the lender attestation;
transferring, by the marketplace, the tokens in the target currency to the buyer, wherein the buyer submits the tokens in the target currency to a staking smart contract; and
transferring, by the marketplace, the tokens in the target currency to the lender at maturity.

9. The method of claim 8, wherein at least one of the submissions further comprises an attestation requirement, and the matching is further based on the attestation requirement and the attestations.

10. The method of claim 8, wherein the matching is further based on a regional requirement.

11. The method of claim 8, wherein the matching is further based on a regulatory requirement or a legal requirement.

12. The method of claim 8, wherein the buyer attestation is blockchain-based and attests to the buyer's authority, and the lender attestation is blockchain-based and attests to the lender's authority.

13. The method of claim 8, wherein the submissions further comprise a digital identifier, and the smart contract further validates the digital identifier for the matched parties.

14. The method of claim 8, further comprising:
receiving, from a pricing oracle, pricing information for the target currency comprising a current APY for the target currency; and
triggering the transfer of the tokens in the target currency to the buyer in response to the current APY matching the target APY.

15. A system for intraday foreign exchange using distributed ledger technology, comprising:
a marketplace comprising a matching engine; and
a distributed ledger network comprising a plurality of smart contracts, wherein a plurality of buyers and a plurality of lenders access the distributed ledger network;
wherein:
the matching engine receives a buyer submission comprising an identification of a first currency, an identification of a target currency, an amount of the target currency, a target annual percentage yield (APY), a maturity, and a buyer attestation;
the matching engine receives a lender submission identifying an amount of tokens in the target currency available for exchange, a fee, and a lender attestation;
the matching engine matches the buyer to the lender based on the buyer submission and the lender submission;
one of the smart contracts verifies the buyer attestation and the lender attestation;
the marketplace transfers the tokens in the target currency to the buyer, wherein the buyer submits the tokens in the target currency to a staking smart contract; and
the marketplace transfers the tokens in the target currency to the lender at maturity.

16. The system of claim 15, wherein at least one of the submissions further comprises an attestation requirement, and the matching is further based on the attestation requirement and the attestations.

17. The system of claim 15, wherein the matching is further based on a regional requirement, a regulatory requirement, and/or a legal requirement.

18. The system of claim 15, wherein the buyer attestation is blockchain-based and attests to the buyer's authority, and the lender attestation is blockchain-based and attests to the lender's authority.

19. The system of claim 15, wherein the submissions further comprise a digital identifier, and the smart contract further validates the digital identifiers for the matched parties.

20. The system of claim 15, further comprising:
a pricing oracle;
wherein the marketplace receives pricing information for the target currency comprising a current APY for the target currency and triggers the transfer of the tokens in the target currency to the buyer in response to the current APY matching the target APY.
